(19) United States
(12) Patent Application Publication
(10) Pub. No.: US 2008/0131169 A1
(43) Pub. Date: Jun. 5, 2008

(54) Charging device, and image-forming apparatus and image-forming unit using the same

(75) Inventors: Yuki Nagamori, Kanagawa (JP); Hiroyuki Miura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/826,323

(22) Filed: Jul. 13, 2007

(30) Foreign Application Priority Data
Nov. 30, 2006 (JP) P2006-324248

(51) Int. Cl. G03G 15/02

(52) U.S. Cl. 399/174; 399/176

(57) ABSTRACT

A charging device includes a charging member that contacts a member to be charged, charges the member with a predetermined voltage applied to the charging member, and includes a surface layer containing a resin solid and a conductive agent of approximately 10 wt. % or more with respect to the resin solid content.

### CROSS-REFERENCE TO RELATED APPLICATIONS

This application is based on and claims priority under 35 USC 119 from Japanese Patent Application No. 2006-324248 filed on Nov. 30, 2006.

### BACKGROUND

### TECHNICAL FIELD

The present invention relates to a charging device, and an image-forming apparatus and image-forming unit which use the device.

### SUMMARY

According to an aspect of the invention, there is provided a charging device including a charging member that contacts a member to be charged, charges the member with a predetermined voltage applied to the charging member, and includes a surface layer containing a resin solid and a conductive agent of about 10 wt. % or more with respect to the resin solid content.

### BRIEF DESCRIPTION OF THE DRAWINGS

Exemplary embodiment(s) of the present invention will be described in detail based on the following figures, wherein:

FIG. 1 is a diagram showing an example of an image-forming apparatus to which the charging device of a first exemplary embodiment is used;

FIG. 2 is a diagrammatic sectional view showing an example of a photosensitive drum of the image-forming apparatus to which the charging device of the first exemplary embodiment is used;

FIG. 3 is a diagram showing the charging device of the first exemplary embodiment;

FIG. 4 is a view showing changes of the life and leakage property of the charging device of the first exemplary embodiment with respect to the additive amount of CB in a surface layer of a charging roll of the charging device;

FIG. 5 is a view showing the leakage property of the charging device with respect to the pH value of the CB added to the surface layer of the charging roll of the charging device of a second exemplary embodiment;

FIG. 6 is a view showing a required voltage grade of the charging device to the volume average particle diameter of a conductive agent added to the surface layer of the charging roll of the charging device of a third exemplary embodiment;

FIG. 7 is a view showing the dispersibility of the conductive agent in the surface layer with respect to a volatile content of the conductive agent added to the surface layer of the charging roll of the charging device of a fourth exemplary embodiment; and

FIG. 8 is a view showing the leakage property of the charging device with respect to the oil absorption of the conductive agent added to the surface layer of the charging roll of the charging device of a fifth exemplary embodiment,

wherein 1 denotes an image-forming apparatus, 11 denotes a process cartridge (image-forming unit), 12 denotes an photosensitive drum (image carrier (member to be charged)), 12B denotes a photosensitive layer, 12d denotes a protective layer, 13 denotes a charging device, 13A denotes a charging roll (charging member), 13B denotes a cleaning roll (cleaning member), and 13c denotes a surface layer.

### DETAILED DESCRIPTION

Hereinafter, exemplary embodiments of the invention will be described with reference to the accompanying drawings.

### First Exemplary Embodiment

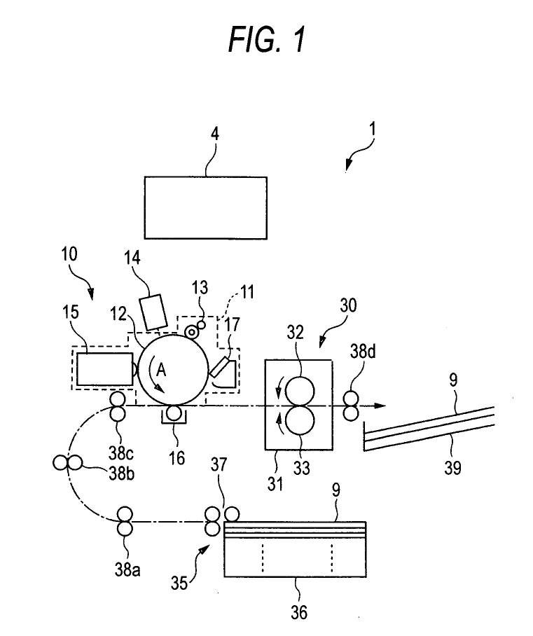

FIGS. 1 to 4 are views showing a first exemplary embodiment of the charging device of the image-forming apparatus of the invention.

FIG. 1 is a diagram showing an example of an image-forming apparatus to which the charging device of the exemplary embodiment is used. As shown in FIG. 1, in the image-forming apparatus 1, an image-producing device 10 which forms a toner image based on image information, and which finally transfers the toner image to a sheet 9, a fixing device 30 through which the toner-image transferred sheet 9 is passed to fix the toner image, and a sheet supplying device 35 which supplies the sheet 9 to the image-producing device 10 are mainly provided inside the apparatus body (not shown). In the figure, the reference numeral 4 denotes a controlling device which comprehensively controls operations of components of the image-forming apparatus 1, and the arrowed one-dot chain line shows a main conveyor path for sheet 9.

The image-producing device 10 forms and transfers a toner image with using the known electrophotographic system or the like. Specifically, the device includes a cylindrical photosensitive drum 12 (image carrier (member to be charged)) which is rotated in the direction of the arrow A. Around the photosensitive drum 12, the following devices are mainly arranged: a charging device 13 including a charging roll which uniformly charges the surface (image-carrying surface) of the photosensitive drum 12; an exposing device 14 configured by an LED array, a laser scanning device, or the like which irradiates the surface of the charged photosensitive drum 12 with a light beam based on the image information (signal) to form a latent image having a potential difference; a developing device 15 which transfers a toner to the latent image to adhere thereto, thereby forming a toner image; a transferring device 16 including a transfer roll which transfers the toner image to the sheet 9 supplied from the sheet supplying device 35; and a blade type cleaning device 17 which removes a toner and the like remaining on the surface of the photosensitive drum 12 after the transfer process to clean the surface.

Among the devices, the photosensitive drum 12 is configured by forming a photoconductive layer (photosensitive layer) made of an organic photosensitive material on a drum-like substrate (conductive supporting member). The photosensitive drum 12 will be described later in detail. In the charging device 13, the charging roll configured by forming a semiconductive elastic layer or the like on a conductive roll substrate (conductive supporting member) is contacted with the surface of the photosensitive drum 12 to be drivenly rotated thereby. A predetermined charging voltage is applied from a power source (not shown) to the charging roll. The charging device 13 will be described later in detail. The exposing device 14 receives the image signal which is obtained by performing a required process in an image processing device (not shown) in the image-forming process on image information that is supplied from an external apparatus such as a document reader or a computer which is connected to or provided in the image-producing device 1.

The developing device 15 is provided with a developing roll for transporting and supplying a toner stored therein to a developing position opposed to the photosensitive drum 12. A predetermined developing voltage is applied from the power source (not shown) to the developing roll. In the transferring device 16, the transfer roll configured by forming a semiconductive elastic layer on a conductive roll substrate is contacted with the surface of the photosensitive drum 12 to be drivenly rotated thereby. A predetermined transferring voltage is applied from the power source (not shown) to the transfer roll. The cleaning device 17 is provided with a cleaning blade or the like in which a tip end portion is butted at a predetermined pressure against the surface of the photosensitive drum 12 after the transfer process.

The fixing device 30 includes inside the body 31: a heating roll 32 which is heated to a predetermined temperature, and which is rotated in the arrow direction; and a pressurizing member 33 such as a pressurizing roll which is pressingly contacted with the heating roll 32 substantially along the axial direction to be drivenly rotated thereby. The fixation is performed by introducing the sheet 9 on which a toner image is transferred, into a pressure contact portion between the heating roll 32 and the pressurizing member 33, thereby heating and pressurizing the toner image and the like.

The sheet supplying device 35 mainly includes: a sheet supply cassette 36 in which plural sheets 9 to be supplied to the image-producing device 10 are stacked and stored; and a feeding mechanism 37 which feeds one by one the sheets 9 stored in the sheet supply cassette 36. As required, plural sheet supply cassettes 36 are disposed. The sheet supplying device 35 further includes a sheet conveyor path for conveying the sheet 9 from the sheet supply cassette 36 to a transferring portion (between the photosensitive drum 12 and the transferring device 16) of the image-producing device 10. The path is configured by sheet conveyor roll pairs 38a, 38b, 38c, . . . , guide members, etc. Other sheet conveyor paths are disposed between the image-producing device 10 and the fixing device 30, and between the fixing device 30 and a sheet discharging portion (a tray and the like) 39. In a sheet discharging side of the fixing device 30, for example, a discharging roll pair 38d for discharging the sheet 9 after the fixing process to the discharging portion 39 is disposed.

In the figure, the reference numeral 11 denotes a process cartridge (image-forming unit) which is attachable to and detachable from the image-forming apparatus 1. The process cartridge 11 in the exemplary embodiment has the process devices, or the photosensitive drum 12, the charging device 13, the developing device 15, and the cleaning device 17.

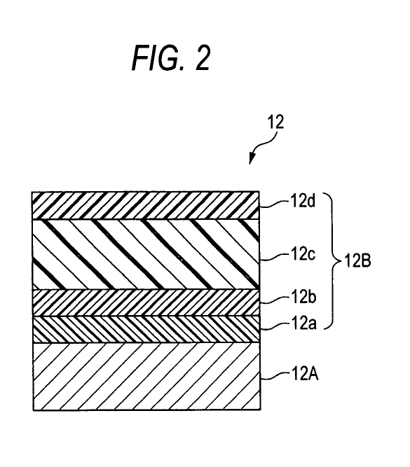

FIG. 2 is a diagrammatic sectional view showing an example of the photosensitive drum of the image-forming apparatus to which the charging device of the exemplary embodiment is used. The photosensitive drum 12 has a structure in which an undercoat layer 12a, a charge generating layer 12b, a charge generating layer 12c, and a protective layer 12d are stacked in this sequence on a conductive supporting member 12A. The undercoat layer 12a, the charge generating layer 12b, the charge generating layer 12c, and the protective layer 12d constitute a photosensitive layer 12B.

The protective layer 12d is made of a hardened material of a hardening resin composition containing an alcohol-soluble hardening resin and alcohol-soluble polyether. For example, the hardening resin is a phenol resin having a crosslinked structure.

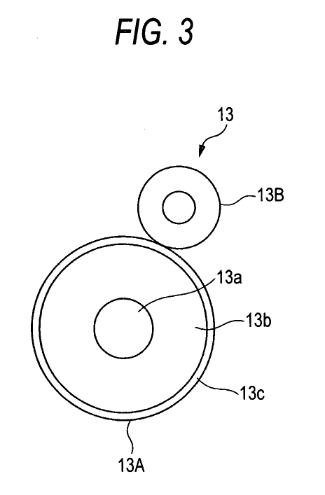

FIG. 3 is a diagram showing the charging device of the exemplary embodiment. The charging device 13 has the charging roll 13A (charging member) and a cleaning roll 13B (cleaning member). The charging roll 13A is configured by a conductive supporting member 13a, an elastic layer 13b which is formed integrally with the outer periphery of the member, and a surface layer 13c which is a cover layer formed in the peripheral face of the elastic layer 13b. The cleaning roll 13B is contacted with the surface of the charging roll 13A so as to be drivenly rotated. For example, the cleaning roll 13B is formed by a sponge-like member.

As the conductive supporting member 13a of the charging roll 13A, a round bar of a metal material such as iron, copper, stainless steel, aluminum, or nickel may be used. In order to provide the surface of the metal with the anti-rust and anti-scratch properties, a plating process may be applied on the surface of the metal. However, it is required not to impair the conductivity.

The elastic layer 13b of the charging roll 13A is provided with adequate conductivity and elasticity in order to ensure the power supply to the photosensitive drum 12 which is a member to be charged, and the excellent uniform contacting property between the charging roll 13A and the photosensitive drum 12. In order that the uniform contacting property is ensured between the charging roll 13A and the photosensitive drum 12, the elastic layer 13b may be formed by polishing into a so-called crown shape in which a middle portion is thickest and the thickness is gradually further lowered as more advancing toward the ends.

The conductivity of the elastic layer 13b is adjusted by adding a conductive material such as carbon black (CB) into an elastic material such as rubber.

The elasticity of the elastic layer 13b is adjusted by adding a process oil, a plasticizing agent, or the like.

Specific examples of the elastic material of the elastic layer 13b are natural rubber, synthetic rubber such as silicone rubber and urethane rubber, and resins such as a polyimide resin, a polyurethane resin, and a silicone resin.

In order to control the resistance of the charging roll 13A, a resistance controlling layer may be disposed between the elastic layer 13b and the surface layer 13c. Specific examples of the material of the resistance controlling layer are resins such as a polyamide resin, a polyurethane resin, a fluorine resin, and a silicone resin, epichlorohydrin, urethane rubber, chloroprene, and acrylonitrile rubber. A conductive material such as carbon black, tin oxide, or titanium oxide may be dispersed also in the resistance controlling layer.

To the surface layer 13c of the charging roll 13A, 10 wt. % or more, or about 10 wt. % or more of a conductive agent with respect to the resin solid content is added (the additive amount of the CB is 10% or more, or about 10% or more).

Examples of the conductive agent of the surface layer 13c are fine powders of: carbon black (CB) such as Ketchen black and acethylene black; pyrolytic carbon, graphite; various conductive metals and alloys such as aluminum, copper, nickel, and stainless steel; various conductive metal oxides such as tin oxide, indium oxide, titanium oxide, tin oxide-antimony oxide solid solution, and tin oxide-indium oxide solid solution; and a material in which the surface of an insulative material is processed to be made conductive.

Examples of the resin of the surface layer 13c are polymer materials such as polyamide, polyurethane, polyvinylidene fluoride, tetrafluoroethylene copolymer, polyester, polyimide, silicone resin, acrylic resin, polyvinylbutyral, ethylene-tetrafluoroethylene copolymer, melamine resin, fluoro-rubber, epoxy resin, polycarbonate, polyvinyl alcohol, cellulose, polyvinylidene chloride, polyvinyl chloride, polyethylene, and ethylene-vinyl acetate copolymer. The polymer materials may be used singly, or two or more of them may be mixedly used.

In the exemplary embodiment, as a specific example, the surface layer 13c is produced in the following manner.

As the resin, Amilan nylon resin CM8000 (hereinafter, referred to merely as CM8000) which is manufactured by Toray, and which is a polyamide resin is used. As the conductive agent, MONARCH 1000 (manufactured by Cabot Specialty Chemicals Ink) (hereinafter, referred to merely as M1000) which is carbon black, Color Black FW200 (manufactured by Degussa-Huls AG) (hereinafter, referred to merely as FW200), or a mixture in which M1000 and FW200 are mixed together at a ratio of 3:7 is dispersed and dissolved in a solvent of ethanol so that the conductive agent is contained by 10 wt. % or more, or about 10 wt. % or more with respect to 100 of a resin solid content, thereby producing a coating solution for the surface layer.

The coating solution for the surface layer is applied onto the elastic layer 13b by the dipping method to form the surface layer 13c having a thickness of about 5 μm.

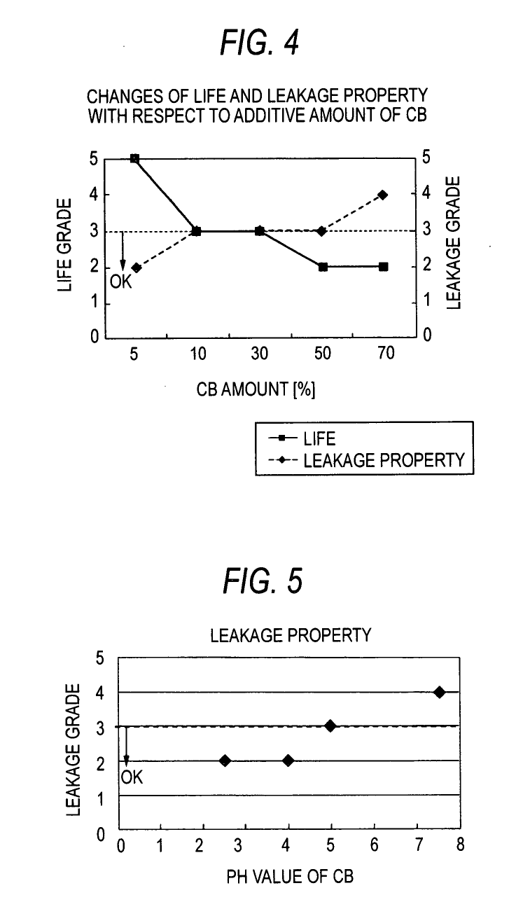

FIG. 4 is a view showing changes of the life and leakage property of the charging device of the exemplary embodiment with respect to the additive amount of the CB in the surface layer of the charging roll of the charging device. The experimental results are obtained in the case where the conductive agent is M1000 and the resin is CM8000.

The life grade is a numerical value indicating the level whether the life is improved or not. A specific method of measuring the life grade will be described below.

Under the condition of low temperature and low humidity, in a state where the charging roll 13A is in contact with the photosensitive drum 12, a constant-current source is connected so that a DC current of 1 mA flows, and the photosensitive drum 12 is driven at a peripheral speed of 200 mm/sec. After driving corresponding to 1,000,000 rotations, the resistance of the charging roll 13A is measured, and a change of the average value of the resistance, and σ (dispersion of the resistance) are calculated. When the amount change of the average value is smaller than 1 digit to the initial value and σ is smaller than 0.2 digits (not as a change amount but as an absolute value), the life grade is 3. When the resistance is larger than 1 digit and 1.5 digits or smaller (not including 1 digit) or σ is 0.2 digits or larger and 0.4 digits or smaller, the life grade is 4. When they are larger than these values, the life grade is 5. When the resistance is 0.6 digits or larger and 1 digit or smaller and σ is 0.1 digits or larger and 0.2 digits or smaller, the life grade is 2. When the resistance is 0.3 digits or larger and 0.6 digit or smaller and σ is 0.1 digits or smaller, the life grade is 1. When the resistance and σ are distributed in different life grades, the lower life grade is basically selected.

The leakage grade is a numerical value indicating the level of acceptability of the leakage property. A method of measuring the leakage grade will be described below.

First, a through hole reaching the substrate is opened in the surface of the photosensitive drum 12. The hole opened in the photosensitive drum 12 has a size of 0.1 mm. With using the photosensitive drum 12 having the hole, a printing operation is actually performed on halftone sheets and white sheets. The sizes of holes which are formed on the print samples are measured to determine the grade. In this case, the voltage applied to the charging roll ranges from 800 V to 1,200 V. The leakage grade indexes are classified according to the situation in the following manner. Leakage grade 1 is in the case where the image deletion is a pinhole-like one of a small diameter (about 0.1 mm), leakage grade 2 is in the case where the deletion is slightly enlarged to 0.5 mm or smaller, leakage grade 3 is in the case where the deletion is 0.5 mm or larger, leakage grade 4 is in the case where leakage extends in the axial direction of the photosensitive member to cause streak-like density unevenness, and leakage grade 5 is in the case where density unevenness of a further degree is caused. In further consideration of detection by the naked eye, when the leakage grade is 3 or less, the anti-leakage property is ensured.

As shown in FIG. 4, when the CB amount (additive amount of the CB) is 5%, the life grade is 5, and the leakage grade is 2. When the CB amount is 10%, the life grade is 3, and the leakage grade is 3. When the CB amount is 30%, the life grade is 3, and the leakage grade is 3. When the CB amount is 50%, the life grade is 2, and the leakage grade is 3. When the CB amount is 70%, the life grade is 2, and the leakage grade is 4.

In the experimental results, as the CB amount is further increased, the life grade is further raised, but the leakage grade is further lowered. From the experimental results, it is preferable that, in the surface layer 13c of the charging roll 13A, M1000 which is a conductive agent is contained by 10 wt. % to 50 wt. % or about 10 wt. % to about 50 wt. % with respect to the solid content of CM8000 which is a resin. When a countermeasure against leakage is taken in the photosensitive drum 12, however, the leakage grade is prevented from being lowered, and the upper limit of the CB amount is increased.

When the conductive agent is contained by 80 wt. % or more, or about 80 wt. % or more with respect to the resin solid content, the viscosity of the coating solution for the surface layer is increased, and hence the thickness of the surface layer may become uneven to cause an image defect such as density unevenness.

The experimental results shown in FIG. 4 are obtained in the case where the conductive agent is M1000 and the resin is CM8000. The same results relating to the life grade are obtained also in the case where the conductive agent is FW200 and the resin is CM8000 , and in the case where the conductive agent is obtained by mixing M1000 and FW200 at a ratio of 3:7, and the resin is CM8000.

### Second Exemplary Embodiment

Next, a second exemplary embodiment of the charging device of the image-forming apparatus of the invention will be described.

In the charging device 13 of the exemplary embodiment, the conductive agent contained in the surface layer 13c of the charging roll 13A of the charging device 13 of the first exemplary embodiment is carbon black (CB) having an hydrogen index (pH value) of 5 or less, or about 5 or less.

FIG. 5 is a view showing the leakage property of the charging device with respect to the pH value of the CB added to the surface layer of the charging roll of the charging device of the exemplary embodiment. The experimental results are obtained in the case where, in the surface layer 13c of the charging roll 13A, the CB is contained by 10 wt. % or about 10 wt. % with respect to a resin solid content. The leakage grade is a numerical value indicating the level of acceptability of the leakage property. When the leakage grade is 3 or less, the anti-leakage property is ensured.

As shown in FIG. 5, when the pH value of the CB is 2.5, the leakage grade is 2. When the pH value of the CB is 4, the leakage grade is 2. When the pH value of the CB is 5, the leakage grade is 3. When the pH value of the CB is 7.5, the leakage grade is 4.

The experimental results show that, when the pH value of the CB added to the surface layer 13c of the charging roll 13A is 5 or less, the resistance difference to the resin of the surface layer 13c of the charging roll 13A may be reduced, and an abnormal discharge hardly occurs. When the pH value is 5 or less, therefore, the sensitivity of the resistance with respect to the CB amount added to the surface layer 13c of the charging roll 13A becomes dull, and, even in the case where the CB amount added to the surface layer 13c of the charging roll 13A is increased, a point of inflection is hardly produced.

The pH value of the CB is measured according to DIN ISO 787/9. Specifically, an aqueous solution of the CB is prepared, and the pH value of the CB is measured with using glass electrodes.

### Third Exemplary Embodiment

Next, a third exemplary embodiment of the charging device of the image-forming apparatus of the invention will be described.

In the charging device 13 of the exemplary embodiment, the conductive agent contained in the surface layer 13c of the charging roll 13A of the charging device 13 of the first exemplary embodiment has an average particle diameter of 5 nm to 50 nm or about 5 nm to about 50 nm.

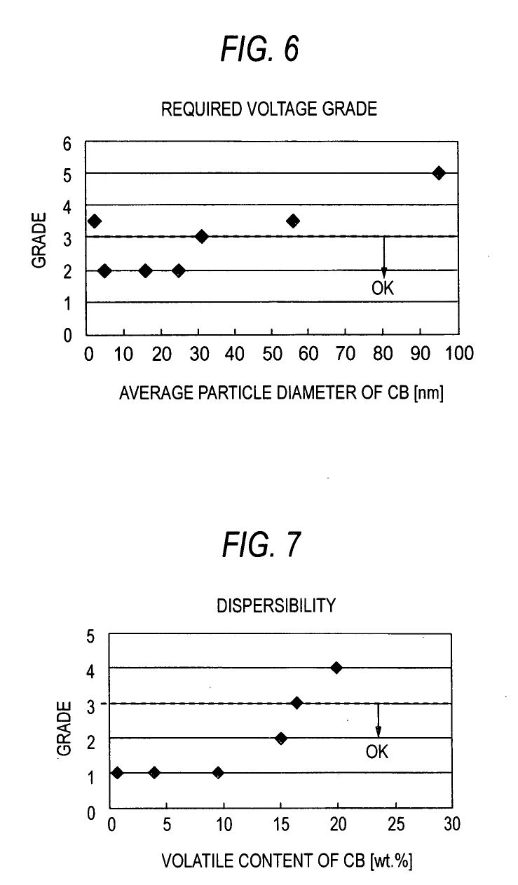

FIG. 6 is a view showing a required voltage grade of the charging device to the volume average particle diameter of the conductive agent added to the surface layer of the charging roll of the charging device of the exemplary embodiment. The experimental results are obtained in the case where the conductive agent added to the surface layer 13c of the charging roll 13A is carbon black (CB). The required voltage grade is a numerical value indicating the level of a charging voltage applied to the charging roll 13A.

Hereinafter, the required voltage grade will be described. First, in order to obtain the relationship of Vpp-Vh, the potential of the photosensitive member in the case where the applied voltage Vpp is changed is evaluated. In the case of application of the voltage Vpp which is higher than Vpp(th) of the point of inflection produced when the voltage applied to the charging roll is raised, Vpp(op) at which an image defect such as a white or black spot due to a charge failure disappears is extracted. The ratio of the two values of Vpp (the value of the point of inflection and that at which an image defect disappears) is defined as a margin. When the margin is 10% or less, the required voltage grade is 1 (in a low-temperature and low-humidity environment of 10° C. and 15% RH). When the margin is 15% or less, the required voltage grade is 2. When the margin is 20% or less, the required voltage grade is 3. When the margin is 25% or less, the required voltage grade is 4. When the margin is larger than the value, the required voltage grade is 5. In the evaluation, the peripheral speed of the photosensitive member is 165 mm/sec, the frequency of the applied voltage is 1,306 Hz, and the thickness of the photosensitive member is 24 μm. When the required voltage grade is 3 or less, the charging voltage is suppressed to be low.

As shown in FIG. 6, when the average particle diameter of the CB is 2.5 nm, the required voltage grade is 3.5. When the average particle diameter of the CB is 5 nm, the required voltage grade is 2. When the average particle diameter of the CB is 16 nm, the required voltage grade is 2. When the average particle diameter of the CB is 25 nm, the required voltage grade is 2. When the average particle diameter of the CB is 31 nm, the required voltage grade is 3. When the average particle diameter of the CB is 56 nm, the required voltage grade is 3.5. When the average particle diameter of the CB is 95 nm, the required voltage grade is 5.

The experimental results show that, in the range where the average particle diameter is 5 nm to 50 nm or about 5 nm to about 50 nm, the distance of CB particles is small, and hence hopping conduction stably occurs, so that the charge uniformity of the charging device may be ensured even at a low charging voltage.

Hereinafter, a specific example of the measurement of the average particle diameter of the CB used in the exemplary embodiment will be described.

An amount of 2 to 20 mg of CB particles which are sufficiently washed and dried are placed on a carbon adhesive tape applied to a SEM sample holder, and platinum deposition is performed. Thereafter, the sample is photographed at 5,000-fold magnification with a scanning electron microscope (FE-SEM S-800, a product of Hitachi, Ltd.). Based on the photograph, the diameters of particles of 0.005 μm or more are measured are measured until the accumulation number reaches 500. In each of particles, an average value of the length (L1) of the longest axis and the length (L2) of an axis perpendicular to the longest axis is set as the diameter of the particle. The average of the thus obtained diameters is set as the average particle diameter.

### Fourth Exemplary Embodiment

Next, a fourth exemplary embodiment of the charging device of the image-forming apparatus of the invention will be described.

In the charging device 13 of the exemplary embodiment, the conductive agent contained in the surface layer 13c of the charging roll 13A of the charging device 13 of the first exemplary embodiment has a volatile content of 16.5 wt. % or less, or about 16.5 wt. % or less.

FIG. 7 is a view showing the dispersibility of the conductive agent in the surface layer with respect to a volatile content of the conductive agent added to the surface layer of the charging roll of the charging device of the exemplary embodiment. The experimental results are obtained in the case where the conductive agent added to the surface layer 13c of the charging roll 13A is carbon black (CB). The grade of the dispersibility is a numerical value indicating the level of acceptability of the dispersibility of the CB in the surface layer 13c of the charging roll 13A.

Hereinafter, the dispersibility grade will be described. The dispersibility grade means the distribution state of CB secondary clusters in the case where a surface-layer coating composition is applied to a glass plate and the plate is observed under a microscope. The dispersibility grade is classified according to the average particle diameter of CB secondary clusters which exist in an area of 100 μm² in the case where a surface-layer coating composition is applied to a glass plate and the plate is observed under a microscope. When the average particle diameter is in the range from a size which is approximately equal to the surface layer thickness to 80% of the thickness, the dispersibility grade is 5 (for example, 3.6 μm or more in the case where the surface layer thickness is 4 μm). When the average particle diameter is 50 to 80%, the dispersibility grade is 4. When the average particle diameter is 30 to 50%, the dispersibility grade is 3. When the average particle diameter is 15 to 30%, the dispersibility grade is 2. When the average particle diameter is 15% or less, the dispersibility grade is 1. The average particle diameter is obtained from a diameter corresponding to a projected area circle-equivalent diameter in the microscopy (the diameter is the diameter of a circle having an area equal to a projected area of a particle, and also called a Heywood diameter). When the dispersibility grade is 3 or less, this means that the dispersibility is improved.

As shown in FIG. 7, when the volatile content of the CB is 0.7 wt. %, the dispersibility grade is 1. When the volatile content of the CB is 4 wt. %, the dispersibility grade is 1. When the volatile content of the CB is 9.5 wt. %, the dispersibility grade is 1. When the volatile content of the CB is 15 wt. %, the dispersibility grade is 2. When the volatile content of the CB is 16.5 wt. %, the dispersibility grade is 3. When the volatile content of the CB is 20 wt. %, the dispersibility grade is 4.

The experimental results show that, as the volatile content of the CB is lower, the compatibility with a resin is higher.

The volatile content of the CB is measured according to DIN 53552. The measurement of the volatile content of the CB is performed after the CB is heated to 950° C. for 7 minutes.

### Fifth Exemplary Embodiment

Next, a fifth exemplary embodiment of the charging device of the image-forming apparatus of the invention will be described.

In the charging device 13 of the exemplary embodiment, the conductive agent contained in the surface layer 13c of the charging roll 13A of the charging device 13 of the first exemplary embodiment has an oil absorption of 140 ml/100 g or less, or about 140 ml/100 g or less.

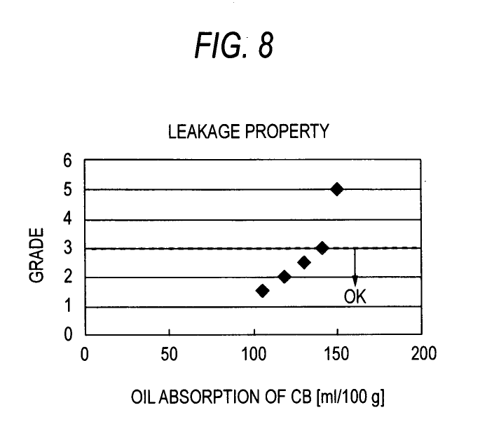

FIG. 8 is a view showing the leakage property of the charging device with respect to the oil absorption of the conductive agent added to the surface layer of the charging roll of the charging device of the exemplary embodiment. The experimental results are obtained in the case where the conductive agent added to the surface layer 13c of the charging roll 13A is carbon black (CB). The grade of the leakage property is a numerical value indicating the level of acceptability of the leakage property. When the grade of the leakage property is 3 or less, the anti-leakage property is ensured.

As shown in FIG. 8, when the oil absorption of the CB is 105 ml/100 g, the grade of the leakage property is 1.5. When the oil absorption of the CB is 118 ml/100 g, the grade of the leakage property is 2. When the oil absorption of the CB is 130 ml/100 g, the grade of the leakage property is 2.5. When the oil absorption of the CB is 141 ml/100 g, the grade of the leakage property is 3. When the oil absorption of the CB is 150 ml/100 g, the grade of the leakage property is 5.

The experimental results show that, when CB having an oil absorption of 140 ml/100 g or less, or about 140 ml/100 g or less is used as the conductive agent, the structure conformation of the CB is hardly produced, and therefore a conducting path is hardly formed even when a large amount of CB is dispersed in the surface layer 13c, whereby the anti-leakage property is improved.

The oil absorption of the CB is measured according to DIN ISO 787/5. Specifically, the CB is mixed with linseed oil to form a paste, and the ratio of the linseed oil to the CB is measured at the timing when the paste becomes fluidized.

The invention is not restricted to the exemplary embodiments, and various modifications may be possible within the scope of the spirit of the invention.

When the charging device 13 of the invention is used, the usable application voltage may be lowered under all environments ranging from a low-temperature and low-humidity environment to a high-temperature and high-humidity environment, and therefore the amount of discharge products may be suppressed to the minimum.

Hereinafter, the configurations and effects of the exemplary embodiments will be enumerated.

In the exemplary embodiments, the amount of the CB is large, and hence the surface roughness is greater as compared with the case of the normal amount. When the conductive agent is contained less than 10 wt. % with respect to 100 of the resin solid content, the surface roughness Rz is 1 to 2 μm. In the exemplary embodiments, by contrast, the surface roughness is about 2 to 4 μm, and, in a larger case, about 7 μm. In the case where the surface roughness Rz is about 1 to 2 μm, depending on the combination of the surface roughness and the cleaning roll 13B to be contacted, filming (laminated fixation) of an external additive contained in a toner occurs, and the filming is printed as an image defect. In the case where the surface roughness Rz is 2 μm or more, in a combination of the surface roughness and the cleaning roll 13B, filming hardly occurs (concave and convex portions are formed, and hence the external additive is hardly coupled together in a linear manner).

In the exemplary embodiments, a configuration in which a phenol resin having a crosslinked structure is used as the protective layer 12d of the photosensitive drum 12 may be employed. The thus configured photosensitive drum 12 has a function of a protective layer, and contributes to the extension of the life of the photosensitive drum 12. However, a discharge attack (sputtering) on the photosensitive drum 12 caused by discharge of the charging roll 13A, and adhesion of discharge products to the photosensitive drum 12 easily occur. These phenomenon become worse as the voltage Vpp applied to the charging roll 13A is higher. When, as in the exemplary embodiments, the required voltage grade is 3 or less and the charging voltage is set to be low, therefore, the characteristics of a phenol resin having a crosslinked structure may be compensated.

What is claimed is:

1. A charging device comprising:
a charging member that contacts a member to be charged, charges the member with a predetermined voltage applied to the charging member, and includes a surface layer containing a resin solid and a conductive agent of about 10 wt. % or more with respect to the resin solid content.

2. The charging device according to claim 1,
wherein the surface layer contains the conductive agent of about 10 wt. % or more and about 50 wt. % or less with respect to the resin solid content.

3. A charging device comprising:
a charging member that contacts a member to be charged, charges the member with a predetermined voltage applied to the charging member, and includes a surface layer containing a resin solid and a conductive agent of about 10 wt. % or more with respect to the resin solid content,
wherein the conductive agent is carbon black having a hydrogen index of about 5 or less.

4. The charging device according to claim 1,
wherein the conductive agent has an average particle diameter of about 5 nm to about 50 nm.

5. The charging device according to claim 1,
wherein the conductive agent contains a volatile content of about 16.5 wt. % or less.

6. The charging device according to claim 1,
wherein the conductive agent has an oil absorption of about 140 ml/100 g or less.

7. The charging device according to claim 1, further comprising:
a cleaning member that contacts and cleans the surface layer.

8. An image-forming apparatus comprising:
the charging device according to claim 1,
wherein the member to be charged is an image carrier that carries an image.

9. The image-forming apparatus according to claim 8,
wherein the image carrier includes a photosensitive layer that has a protective layer made of a phenol resin having a crosslinked structure.

10. An image-forming unit comprising:
an image carrier that is the member to be charged; and
a charging device according to claim 1.
